(19) United States
(12) Patent Application Publication
(10) Pub. No.: US 2026/0241366 A1
(43) Pub. Date: Aug. 20, 2026

(54) POROUS MATERIAL FOR HYDROGEN PURIFICATION AND METHOD FOR PRODUCING SAME, AND HYDROGEN PURIFICATION APPARATUS

(71) Applicant: OSAKA GAS CHEMICALS CO., LTD., Osaka-Shi, Osaka (JP)

(72) Inventors: Masuhiro ABE, Osaka-Shi, Osaka (JP); Yuhei MORITA, Osaka-Shi, Osaka (JP)

(21) Appl. No.: 19/162,137

(22) PCT Filed: Feb. 21, 2024
(86) PCT No.: PCT/JP2024/006315

§ 371 Date: Sep. 4, 2025

(30) Foreign Application Priority Data
Mar. 9, 2023 (JP) 2023-036499

(51) Int. Cl. B01J 20/20; B01D 53/047; B01J 20/28; B01J 20/30; C01B 3/56; C01B 32/324; C01B 32/336

(52) U.S. Cl. CPC B01J 20/20; B01D 53/047; B01J 20/28016; B01J 20/28064; B01J 20/28066; B01J 20/3007; B01J 20/3014; B01J 20/3078; C01B 3/56; C01B 32/324; C01B 32/336; B01D 2253/102; B01D 2253/306; B01D 2253/308; B01D 2253/311; B01D 2256/16; B01D 2257/504; B01D 2257/7025; C01B 2203/042; C01B 2203/0475; C01B 2203/048

(57) ABSTRACT

An object of the present invention is to provide a porous material that has high adsorption and desorption performance for impurities, particularly, methane and carbon dioxide, when used as an adsorbent in a PSA method, and can efficiently perform hydrogen purification, and a method for producing the same, and a hydrogen purification apparatus. In the porous material for hydrogen purification of the present invention, an amount of acetone adsorbed is 12.5% by mass fraction or more, and a pore volume per unit volume of a pore having a size of 0.6 nm or larger and 1.5 nm or smaller is 0.140 mL/mL or more.

### TECHNICAL FIELD

The present invention relates to a porous material for hydrogen purification and a method for producing the same, and a hydrogen purification apparatus.

### BACKGROUND ART

Hydrogen has been expected to have drastic increase in demand in heat sources, fuel cells, and other applications, in recent controversial energy conversion as well as direct power generation, petrochemical industry, and as an atmosphere gas necessary for production of high-tech products such as semiconductors and new ceramics, and as clean energy that replaces conventional hydrocarbon starting materials because of emitting no carbon dioxide during combustion.

A typical example of a method for separating and purifying hydrogen includes a pressure swing adsorption method (hereinafter, also referred to as a “PSA method”). The PSA method is a method of using an adsorbent such as a carbon molecular sieve and removing impurities such as methane, carbon dioxide, carbon monoxide, and nitrogen except for hydrogen by adsorption and desorption from hydrogen-containing gases such as steam-reformed gases derived from, for example, off-gas from petrochemical plants, natural gases, and naphtha; coke oven gases; and reformed gases obtained through the reaction of methane or methanol with water vapor.

Activated carbon molecular sieves are under many studies for more improving their adsorption and desorption performance.

For example, Patent Document 1 describes a carbon molecular sieve for hydrogen purification in which the sizes and distributions of micropores and macropores are controlled.

### CITATION LIST

### Patent Document

Patent Document 1: Japanese Patent Laid-Open No. 6-63397

### SUMMARY OF INVENTION

### Technical Problem

However, the carbon material described in Patent Document 1 has a problem of a small amount of impurity gases adsorbed because a specific surface area is limited to a range as low as 500 m²/g or more and 750 m²/g or smaller. In addition, this carbon material has a problem of low desorption performance for impurities, particularly, methane and carbon dioxide, because an average pore size of micropores is limited to a pore size range as small as 0.6 nm or larger and 0.7 nm or smaller. Due to these problems, an amount of impurity gases, particularly, methane and carbon dioxide, adsorbed in an adsorption step is small in hydrogen purification, and the desorption of the impurity gases, particularly, methane and carbon dioxide, in a desorption step does not sufficiently progress, leading to a problem of poor efficiency of hydrogen purification.

The present invention has been made in light of these problems. An object of the present invention is to provide a porous material that has high adsorption and desorption performance for impurities, particularly, methane and carbon dioxide, when used as an adsorbent in a PSA method, and can efficiently perform hydrogen purification, and a method for producing the same, and a hydrogen purification apparatus.

### Solution to Problem

The present inventors have conducted diligent studies to attain the object and consequently completed the present invention by finding that a specific porous material for hydrogen purification has high adsorption and desorption performance for impurities, particularly, methane and carbon dioxide, and can efficiently perform hydrogen purification in a PSA method.

The present invention includes the following embodiments.

[1]A porous material for hydrogen purification, the porous material being activated carbon, wherein an amount of acetone adsorbed is 12.5% by mass fraction or more, and a pore volume per unit volume of a pore having a size of 0.6 nm or larger and 1.5 nm or smaller is 0.140 mL/mL or more.

[2] The porous material according to [1], wherein a specific surface area is 550 m²/g or more and 1600 m²/g or less, and when the amount of acetone adsorbed is defined as A (% by mass fraction) and a pore volume per unit mass of the pore having a size of 0.6 nm or larger and 1.5 nm or smaller is defined as B (mL/g), an A/B ratio is 72.5 or less.

[3] The porous material according to [1] or [2], wherein when a pore volume per unit mass of the pore having a size of 0.6 nm or larger and 1.5 nm or smaller is defined as B (mL/g) and an amount of hydrogen adsorbed per unit mass at an adsorption temperature of 25° C. and an adsorption pressure of 500 kPa is defined as C (NmL/g), a C/B ratio is 10.5 or less.

[4] The porous material according to any of [1] to [3], wherein a packing density is 0.45 g/mL or more and 0.80 g/mL or less.

[5]

The porous material according to any of [1] to [4], wherein compressive strength per unit area is 0.60 kgf/mm² or more.

[6]

A method for producing a porous material according to any of [1] to [5], containing the step of shaping a starting material containing a carbon powder having a particle size of 0.15 mm or smaller into a granular form.

[7]

A hydrogen purification apparatus containing a porous material according to any of [1] to [5].

### Advantageous Effect of Invention

The present invention can provide a porous material that has high adsorption and desorption performance for impurities, particularly, methane and carbon dioxide, when used as an adsorbent in a PSA method, and can efficiently perform hydrogen purification, and a method for producing the same, and a hydrogen purification apparatus.

### BRIEF DESCRIPTION OF DRAWINGS

FIG. 1a shows respective values of (x1−x2) as to amounts of acetone adsorbed obtained in Examples and Comparative Examples.

FIG. 1b shows respective values of (y1−y2) as to amounts of acetone adsorbed obtained in Examples and Comparative Examples.

FIG. 2a shows respective values of (x1−x2) as to pore volumes per unit volume of a pore having a size of 0.6 nm or larger and 1.5 nm or smaller obtained in Examples and Comparative Examples.

FIG. 2b shows respective values of (y1−y2) as to pore volumes per unit volume of a pore having a size of 0.6 nm or larger and 1.5 nm or smaller obtained in Examples and Comparative Examples.

FIG. 3a shows respective values of (x1−x2) as to specific surface areas obtained in Examples and Comparative Examples.

FIG. 3b shows respective values of (y1−y2) as to specific surface areas obtained in Examples and Comparative Examples.

FIG. 4a shows respective values of (x1−x2) as to A/B ratios obtained in Examples and Comparative Examples.

FIG. 4b shows respective values of (y1−y2) as to A/B ratios obtained in Examples and Comparative Examples.

FIG. 5a shows respective values of (x1−x2) as to C/B ratios obtained in Examples and Comparative Examples.

FIG. 5b shows respective values of (y1−y2) as to C/B ratios obtained in Examples and Comparative Examples.

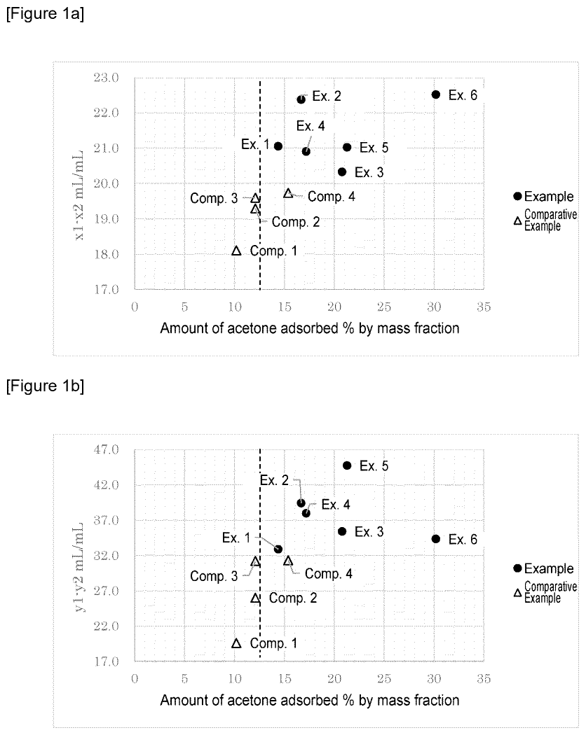

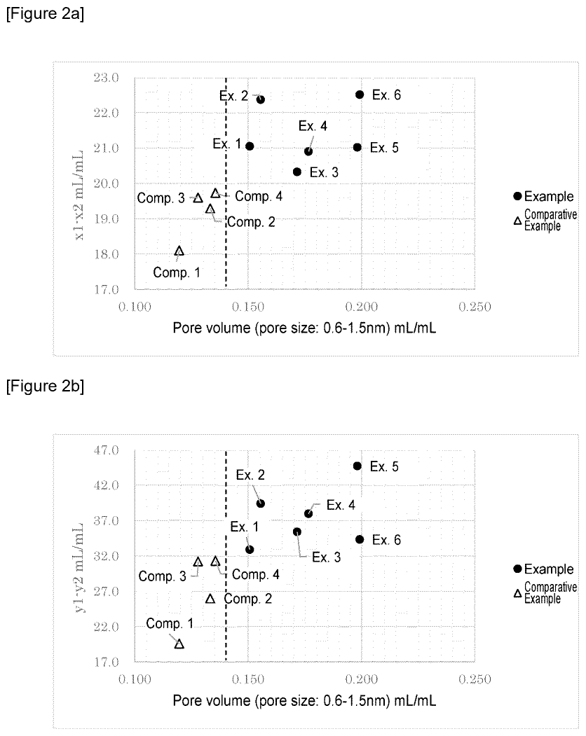

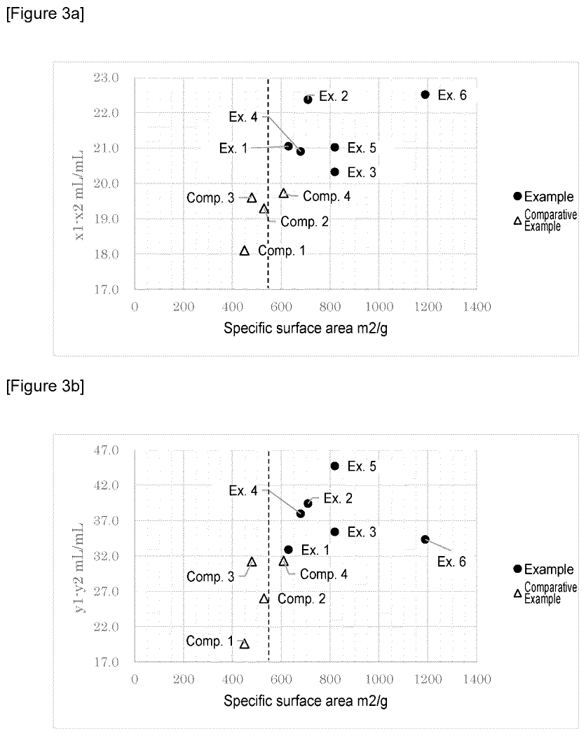

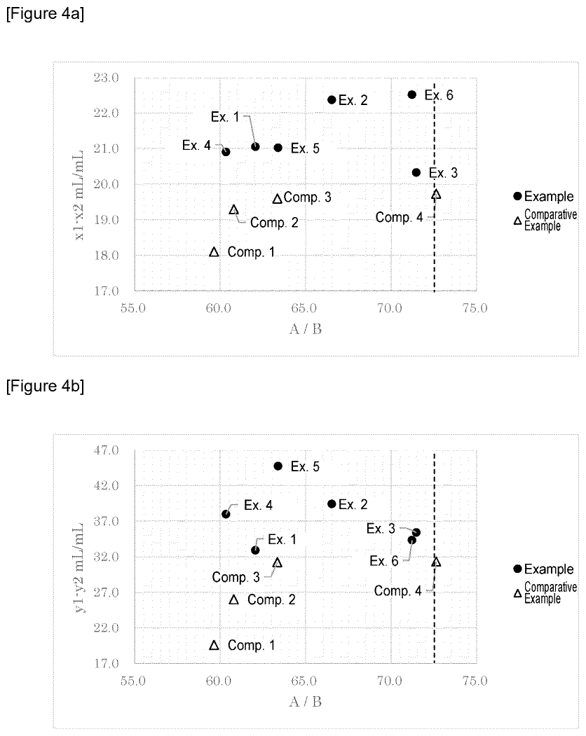

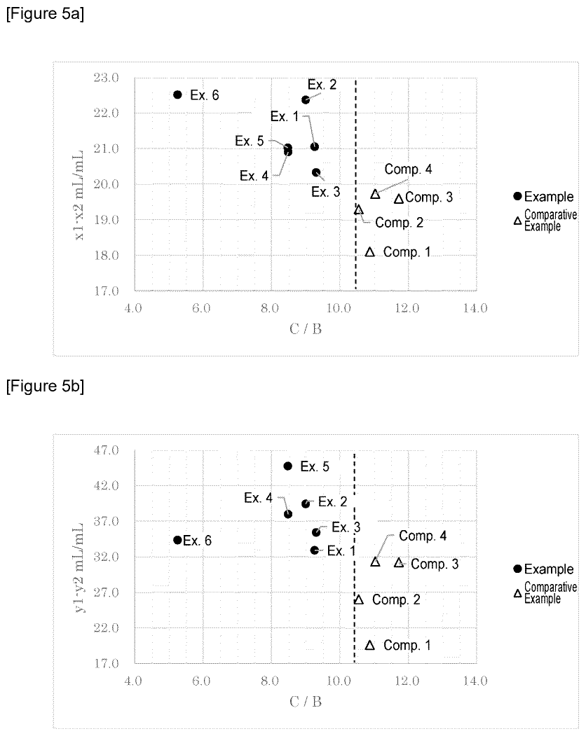

### DESCRIPTION OF EMBODIMENTS

Hereinafter, the mode for carrying out the present invention (hereinafter, simply referred to as the “present embodiment”) will be described in detail. The present embodiment given below is an illustration for describing the present invention, and the present invention is not limited by the present embodiment.

### [Porous Material for Hydrogen Purification]

The porous material for hydrogen purification (hereinafter, also simply referred to as the “porous material”) of the present embodiment has high adsorption and desorption performance for impurities, particularly, methane and carbon dioxide, when used as an adsorbent in a PSA method, and can therefore efficiently separate hydrogen from impurities, particularly, hydrogen from methane and carbon dioxide. Specifically, the porous material of the present embodiment is suitable for a method for selectively separating hydrogen from impurities.

In the porous material of the present embodiment, an amount of acetone adsorbed is 12.5% by mass fraction or more, and a pore volume per unit volume of a pore having a size of 0.6 nm or larger and 1.5 nm or smaller satisfies 0.140 mL/g or more.

The amount of acetone adsorbed is controlled in a proper range, whereby the resulting porous material has high adsorption performance for impurities, particularly, methane and carbon dioxide, and can efficiently perform hydrogen purification. Since the molecular size of acetone is slightly larger than that of methane, the amount of acetone adsorbed which is 12.5% by mass fraction or more means that the porous material has a large total volume of pores onto which methane can be adsorbed. A porous material in which the amount of acetone adsorbed is less than 12.5% by mass fraction tends to be unable to efficiently remove impurity gases because the porous material has a small difference in total volume of pores onto which methane can be adsorbed, and has a small amount of impurity gases that can be adsorbed by one adsorption step when incorporated into a hydrogen purification apparatus. For these reasons, the amount of acetone adsorbed is preferably 12.5% by mass fraction or more, more preferably 13.3% by mass fraction or more, further preferably 14.0% by mass fraction or more. The upper limit of the amount of acetone adsorbed is not particularly limited. A porous material having an exceedingly high amount of acetone adsorbed, i.e., an exceedingly large pore volume, has a relatively large volume of a pore part that occupies the porous material. Therefore, the durability of the porous material tends to be largely reduced. For these reasons, the amount of acetone adsorbed is preferably 40.0% by mass fraction or less, more preferably 35.0% by mass fraction or less, further preferably 30.0% by mass fraction or less. A specific method for measuring the amount of acetone adsorbed can be performed with reference to Examples.

The pore size of the porous material is controlled in a proper range, whereby the resulting porous material has high adsorption performance for impurities, particularly, methane and carbon dioxide, and can efficiently perform hydrogen purification. Particularly, a pore having a pore size of 0.6 nm or larger and 1.5 nm or smaller has high adsorption performance of methane and carbon dioxide. Therefore, when the pore volume per unit volume of a pore having a size of 0.6 nm or larger and 1.5 nm or smaller is 0.140 mL/mL or more, the resulting porous material has high adsorption performance for impurities, particularly, methane and carbon dioxide, and tends to be able to efficiently perform hydrogen purification. If the pore volume per unit volume of a pore having a size of 0.6 nm or larger and 1.5 nm or smaller is less than 0.140 mL/mL, the resulting porous material tends to be unable to efficiently remove impurity gases because pores having high adsorption performance for methane and carbon dioxide are few in number. For these reasons, the pore volume per unit volume of a pore having a size of 0.6 nm or larger and 1.5 nm or smaller is preferably 0.140 mL/mL or more, more preferably 0.145 mL/mL or more, further preferably 0.150 mL/mL or more. The upper limit thereof is not particularly limited. A porous material having an exceedingly large pore volume has a relatively large volume of a pore part that occupies the porous material. Therefore, the durability of the porous material tends to be largely reduced. For these reasons, the pore volume per unit volume of a pore having a size of 0.6 nm or larger and 1.5 nm or smaller is preferably 0.250 mL/mL or less, more preferably 0.230 mL/mL or less, further preferably 0.210 mL/mL or less. A specific method for measuring the pore volume per unit volume of a pore having a size of 0.6 nm or larger and 1.5 nm or smaller can be performed with reference to Examples.

The specific surface area of the porous material of the present embodiment is preferably 550 m²/g or more and 1600 m²/g or less. When the amount of acetone adsorbed is defined as A (% by mass fraction) and a pore volume per unit mass of the pore having a size of 0.6 nm or larger and 1.5 nm or smaller is defined as B (mL/g), the A/B ratio of the porous material of the present embodiment is preferably 72.5 or less.

The specific surface area is controlled in a proper range, whereby the resulting porous material has high adsorption performance for impurities, particularly, methane and carbon dioxide, and tends to be able to efficiently perform hydrogen purification. In the operation of a hydrogen purification apparatus that purifies and separates hydrogen by use of a PSA method, purified hydrogen gas can be continuously generated by alternately repeating an adsorption step of adsorbing impurity gases and a desorption step of desorbing the adsorbed impurity gases to regenerate the porous material as an adsorbent. In this operation, for efficiently purifying hydrogen gas, it is necessary to adsorb impurity gases as much as possible by one adsorption step, i.e., it is necessary to have a sufficient pore volume. In the porous material, the specific surface area is known to tend to have given correlation with the pore volume. The porous material having a specific surface area of 550 m²/g or more tends to have a large pore volume and therefore has a large amount of impurity gases that can be adsorbed by one adsorption step and tends to be able to efficiently remove impurity gases. For these reasons, the specific surface area is preferably 550 m²/g or more, more preferably 590 m²/g or more, further preferably 620 m²/g or more. The upper limit of the specific surface area is not particularly limited. A porous material having an exceedingly high specific surface area, i.e., an exceedingly large pore volume, has a relatively large volume of a pore part that occupies the porous material. Therefore, the durability of the porous material tends to be largely reduced. For these reasons, the specific surface area is preferably 1600 m²/g or less, more preferably 1400 m²/g or less, further preferably 1200 m²/g or less. In the present embodiment, the specific surface area is measured by a BET method. A specific measurement method therefor can be performed with reference to Examples.

The A/B ratio which is a value obtained by dividing the amount of acetone adsorbed (% by mass fraction) (A) by the pore volume per unit mass (mL/g) of the pore having a size of 0.6 nm or larger and 1.5 nm or smaller (B) is properly controlled, whereby the resulting porous material tends to be able to exhibit high desorption performance for impurities, particularly, methane and carbon dioxide. In the operation of a hydrogen purification apparatus that purifies and separates hydrogen by use of a PSA method, purified hydrogen gas can be continuously generated by alternately repeating an adsorption step of adsorbing impurity gases and a desorption step of desorbing the adsorbed impurity gases to regenerate the porous material as an adsorbent. In this operation, for efficiently purifying hydrogen gas, it is necessary to possess both high adsorbability and high desorption performance for impurity gases, particularly, methane and carbon dioxide. By possessing both of these capabilities, one cycle involving the adsorption step and the desorption step tends to be able to remove more impurity gases, owing to a large difference between the amount of impurity gases adsorbed at an adsorption pressure and the amount of impurity gases adsorbed at a desorption pressure. The amount of acetone adsorbed correlates closely to the amount of impurity gases, particularly, methane and carbon dioxide, adsorbed at a desorption pressure. The pore volume of the pore having a size of 0.6 nm or larger and 1.5 nm or smaller correlates closely to the amount of impurity gases, particularly, methane and carbon dioxide, adsorbed at an adsorption pressure. Hence, when the A/B ratio is 72.5 or less, the amount of impurity gases adsorbed at a desorption pressure based on the amount of impurity gases adsorbed at an adsorption pressure tends to be small, i.e., the difference between the amount of impurity gases adsorbed at an adsorption pressure and the amount of impurity gases adsorbed at a desorption pressure tends to be large. For these reasons, the A/B ratio is preferably 72.5 or less, more preferably 72.0 or less, further preferably 71.5 or less. The lower limit of the A/B ratio is not particularly limited. When the A/B ratio falls within the range described above, hydrogen purification tends to be able to be more efficiently performed using a hydrogen purification apparatus. Therefore, the A/B ratio is usually 72.0 or less. A specific method for measuring the pore volume per unit mass of the pore having a size of 0.6 nm or larger and 1.5 nm or smaller can be performed with reference to Examples.

When the pore volume per unit mass of the pore having a size of 0.6 nm or larger and 1.5 nm or smaller is defined as B (mL/g) and an amount of hydrogen adsorbed per unit mass at an adsorption temperature of 25° C. and an adsorption pressure of 500 kPa is defined as C (NmL/g), the C/B ratio of the porous material of the present embodiment is preferably 10.5 or less.

The C/B ratio which is a value obtained by dividing the amount of hydrogen adsorbed per unit mass (NmL/g) at an adsorption temperature of 25° C. and an adsorption pressure of 500 kPa (C) by the pore volume per unit mass (mL/g) of the pore having a size of 0.6 nm or larger and 1.5 nm or smaller (B) is properly controlled, whereby the resulting porous material tends to be able to efficiently perform hydrogen purification. In the operation of a hydrogen purification apparatus, for efficiently isolating hydrogen, it is necessary to allow hydrogen to pass through an adsorption tower without adsorbing hydrogen onto the porous material in an adsorption step. In this respect, when the amount of hydrogen adsorbed per unit mass at an adsorption temperature of 25° C. and an adsorption pressure of 500 kPa is low, hydrogen adsorption performance tends to be low. The pore volume per unit mass of the pore having a size of 0.6 nm or larger and 1.5 nm or smaller (B) tends to correlate closely with the amount of impurity gases, particularly, methane and carbon dioxide, adsorbed at an adsorption pressure. Hence, when the C/B ratio is 10.5 or less, the adsorption performance of hydrogen based on the adsorption performance of methane and carbon dioxide tends to be low. Thus, methane and carbon dioxide tend to be selectively adsorbed while the amount of hydrogen adsorbed is reduced. On the other hand, a porous material having a C/B ratio that exceeds 10.5 tends to have a large amount of hydrogen adsorbed based on a pore volume and therefore tends to be unable to efficiently purify hydrogen due to a relatively large proportion of hydrogen that is released without being recoverable as a product. For these reasons, the C/B ratio is preferably 10.5 or less, more preferably 10.0 or less, further preferably 9.5 or less. The lower limit of the C/B ratio is not particularly limited. When the C/B ratio falls within the range described above, hydrogen purification tends to be able to be more efficiently performed using a hydrogen purification apparatus. Therefore, the C/B ratio is usually 10.5 or less. A specific method for measuring the amount of hydrogen adsorbed per unit mass at an adsorption temperature of 25° C. and an adsorption pressure of 500 kPa can be performed with reference to Examples.

The packing density of the porous material of the present embodiment is preferably 0.45 g/mL or more and 0.80 g/mL or less.

The amount of impurity gases adsorbed per adsorption tower can be increased by packing the adsorption tower of a hydrogen purification apparatus with a larger amount of the porous material. Therefore, hydrogen purification tends to be able to be more efficiently performed. In this respect, the packing density of the porous material is preferably 0.45 g/mL or more, more preferably 0.47 g/mL or more, further preferably 0.50 g/mL or more. The upper limit value of the packing density is not particularly limited. A porous material having an exceedingly high packing density has a relatively low proportion of voids carried by the porous material and therefore tends to be unable to efficiently adsorb impurity gases because the movement of impurity gases to the pores is inhibited in an adsorption step. Thus, the packing density is preferably 0.80 g/mL or less, more preferably 0.75 g/mL or less, further preferably 0.70 g/mL or less, in consideration of tending to be unsuitable as an adsorbent for performing hydrogen purification. A specific method for measuring the packing density may be performed with reference to Examples.

The packing density that falls within the range mentioned above enables a hydrogen purification apparatus that purifies and separates hydrogen by use of a PSA method to be packed with the porous material suitable for hydrogen purification at a high packing density. Hence, such a porous material for use in the hydrogen purification apparatus has higher high adsorption and desorption performance for impurities, particularly, methane and carbon dioxide, and can more efficiently perform hydrogen purification.

The compressive strength per unit area of the porous material of the present embodiment is preferably 0.60 kgf/mm² or more.

For stable operation of a hydrogen purification apparatus for a long time, the porous material needs to have given strength. Low strength of the porous material is responsible for the fracture or powderization of the porous material or the contamination or clogging of piping as the cycle of adsorption and desorption is repeated in the operation of a hydrogen purification apparatus. In this respect, the compressive strength per unit area of the porous material is preferably 0.60 kgf/mm² or more, more preferably 0.65 kgf/mm² or more, further preferably 0.70 kgf/mm² or more. The upper limit of the compressive strength per unit area of the porous material is not particularly limited. When the compressive strength per unit area of the porous material falls within the range described above, a hydrogen purification apparatus tends to be able to be stably operated over a long time. Therefore, the compressive strength per unit area is usually 10.0 kgf/mm² or less. A specific method for measuring the compressive strength per unit area can be performed with reference to Examples.

The shape of the porous material is not particularly limited and can be a shape applicable as a known adsorbent. Examples of such a shape include granular, substrate (sheet), and fiber forms. When the shape of the porous material is a granular form, more specific examples of the shape include rod (columnar), block, spherical, and oval spherical forms. These shapes may be distorted. The shape of the porous material is preferably a granular form. When the shape of the porous material is a granular form, the porous material is more improved in adsorption and desorption performance, is more easily processed, has higher strength, and can have a higher packing density, and tends to be more easily applicable to various applications. The porous material in a granular form tends to be less likely to clog piping or the like during operation of an apparatus such as a hydrogen purification apparatus that purifies and separates hydrogen by use of a PSA method because an unnecessary fine powder is more difficult to generate during operation.

When the shape of the porous material is a granular form, its planarly viewed shape can be, for example, a shape applicable as a known adsorbent. Examples of such a shape include circle, oval, rectangle, rod, and distorted forms in planar view. When the shape of the porous material is a granular form, its size is not particularly limited and can be determined with reference to a known adsorbent. The size is preferably applicable to an apparatus such as a hydrogen separation apparatus that separates and purifies hydrogen by use of a PSA method.

When the shape of the porous material is a granular form, the granules preferably have a maximum diameter of 0.5 mm or larger and 50 mm or smaller and an aspect ratio of 1:1 or more and 1:50 or less. A smaller aspect ratio enables an apparatus such as a hydrogen purification apparatus that purifies and separates hydrogen by use of a PSA method to be packed with the porous material at a higher packing density. Such a porous material in a granular form is more suitable for an apparatus such as a hydrogen separation apparatus that purifies and separates hydrogen by use of a PSA method.

The porous material is preferably applicable to an apparatus such as a hydrogen separation apparatus that purifies and separates hydrogen by use of a PSA method. Examples of such a porous material include activated carbon and zeolite. Among them, the porous material is preferably activated carbon because the porous material has much higher adsorption and desorption performance for impurities, particularly, methane and carbon dioxide and can much more efficiently perform hydrogen purification.

### [Method for Producing Porous Material]

The method for producing the porous material contains, for example, the step of shaping a starting material containing a carbon powder into a granular form. The production method preferably contains: a carbonization step of carbonizing the obtained shaped product in a granular form to obtain carbide; an activation step of subjecting the carbide to activation treatment.

The starting material containing a carbon powder is not particularly limited as long as the desired porous material can be obtained from the material. Examples of the carbon source of the carbon powder include: coal; palm tree kernel shell such as palm kernel shell and coconut kernel shell; natural fiber such as hemp and cotton; synthetic fiber such as rayon and polyester; synthetic resin such as polyacrylonitrile, phenol resin, polyvinylidene chloride, polycarbonate, and polyvinyl alcohol; and charcoal. The carbon powder can be obtained, for example, by carbonizing such a carbon source and then obtaining a predetermined particle size by use of a known crushing or classification technique.

Any one or more materials selected from coal, palm tree kernel shell, synthetic resin, and charcoal is preferably used as the carbon source, and palm tree kernel shell is more preferably used, because each of a pore size and a pore volume can be properly controlled in the porous material and the outer surface area per unit mass of the porous material can be controlled in a suitable range.

Examples of the method for carbonizing the carbon source include, but are not particularly limited to, a method involving heating to 300° C. or higher and 900° C. or lower, more preferably 300° C. or higher and 800° C. or lower, under an oxygen-free condition. The carbonization time can be appropriately set depending on the starting material and a facility where carbonization is performed. The carbonization time is, for example, on the order of 15 minutes or longer and 20 hours or shorter, preferably on the order of 30 minutes or longer and 10 hours or shorter. The carbonization treatment is performed in a nitrogen atmosphere using, for example, a known production facility such as a rotary kiln. After carbonization, for example, washing treatment and drying treatment may be performed. Their conditions are not particularly limited, and known conditions can be adopted.

A smaller particle size of the carbon powder increases the outer surface area of the carbon powder, can increase the amount of an adsorption site generated in the subsequent activation step, and produces a porous material that has higher adsorption performance and desorption performance for impurities, particularly, methane and carbon dioxide, and can more efficiently perform hydrogen purification. On the other hand, an exceedingly small particle size of the carbon powder causes reduction in production capacity in a crushing step for the carbon source and reduction in workability due to the scattering of the powder. For these reasons, the particle size (average particle size, D50) of the carbon powder is preferably controlled in the range of 0.001 mm or larger and 0.150 mm or smaller, more preferably controlled in the range of 0.001 mm or larger and 0.100 mm or smaller, and further preferably controlled in the range of 0.001 mm or larger and 0.050 mm or smaller. The outer surface area is preferably 0.01 m²/g or more and 20 m²/g or less, more preferably 0.1 m²/g or more and 10 m²/g or less, further preferably 0.3 m²/g or more and 5 m²/g or less. The porous material obtained by producing the porous material using the carbon powder finely crushed so as to have an average particle size in a predetermined range is capable of having higher adsorption and desorption performance for impurities, particularly, methane and carbon dioxide. Specific methods for measuring the particle size (average particle size, D50) and the outer surface area can be performed with reference to Examples.

The starting material containing a carbon powder may optionally contain an additive or the like. Examples of such an additive include water, creosote oil (see Japanese Patent No. 4893944), lignin (e.g., SAN X® manufactured by Nippon Paper Industries Co., Ltd.), coal tar, coal tar-based pitch, and petroleum-based pitch. One of these additives may be used singly, or two or more thereof may be used in combination.

Each additive is usually added at 0.1 parts by mass or more and 50 parts by mass or less per 100 parts by mass of the carbon powder. The total amount of the additives is usually 0.1 parts by mass or more and 50 parts by mass or less per 100 parts by mass of the carbon powder.

The method for shaping the starting material containing a carbon powder into a granular form is not particularly limited. The starting material can be subjected to known mixing (kneading), stirring, shaping, and drying depending on quality required for the porous material to obtain a shaped product in a granular form.

The mixing and stirring methods may be known methods. Examples thereof include mixing and stirring using a blender or a Henschel mixer.

Examples of the shaping method include a method of producing a shaped product in a granular form having a predetermined shape such as a cylindrical form from the starting material using an extrusion granulator such as a disc pelletizer.

The length of the diameter in the cross-sectional shape of the shaped product in a granular form is not particularly limited and is, for example, on the order of 0.5 mm or larger and 50 mm or smaller. In the present specification, the “diameter” when the cross-sectional shape is a circle means the diameter of the circle. On the other hand, when the cross-sectional shape is an ovoid, an oval, or an ellipse, the “diameter” means the longest direction (i.e., the longitudinal direction) in these shapes. In the present specification, the “circle” encompasses a true circle as well as an ovoid, an oval, and an ellipse.

When the shaped product in a granular form is in a cylindrical form, the length in the axial direction of the cylinder is not particularly limited and is, for example, on the order of 0.5 mm or larger and 50 mm or smaller.

In the present embodiment, the diameter and the length in the axial direction of the shaped product in a granular form can be measured by known methods. Examples of such methods include measurement using a measurement tool such as a caliper, and magnification of a shaped product of activated carbon under an optical microscope or an electron microscope, followed by measurement using a measure on a magnified image. The number of measurements is not particularly limited and is usually on the order of 30 measurements as a reference.

The carbonization method for carbonizing the obtained shaped product in a granular form to obtain carbide is not particularly limited. For example, the method for carbonizing the carbon source mentioned above can be adopted. The carbonization treatment can employ a known production facility such as a rotary kiln or a fluidized-bed incinerator. Particularly, the shaped product in a granular form is preferably carbonized using a rotary kiln because the carbonization treatment can be performed without limitations on the size of the shaped product in a granular form.

A known method can be adopted to the activation method for subjecting the obtained carbide to activation treatment. Examples of such a method include activation methods with active gases such as water vapor, oxygen, and carbon dioxide. The activation treatment can employ a known production facility such as a rotary kiln or a fluidized-bed incinerator. Particularly, the carbide in a granular form is preferably activated using a rotary kiln because the activation treatment can be performed without limitations on the size of the carbide in a granular form. In the case of using, for example, carbon dioxide, examples of the activation treatment include a method of contacting the carbide with carbon dioxide at a flow rate of 10 L or more and 300 L or less per minute for a time on the order of 0.25 hours or longer and 120 hours or shorter. In the case of using, for example, water vapor, examples thereof include a method of contacting the carbide with water vapor at a flow rate of 10 L or more and 300 L or less per minute for a time on the order of 0.25 hours or longer and 48 hours or shorter.

The temperature of the activation treatment is not particularly limited and is preferably 750° C. or higher and 1200° C. or lower, more preferably 800° C. or higher and 1100° C. or lower, because each of a pore size and a pore volume can be properly controlled in the porous material and the outer surface area per unit mass of the porous material can be controlled in a suitable range.

The time of the activation treatment can be adjusted to an appropriate range depending on conditions such as the starting material, the activation temperature, and a production facility. The activation time is preferably 0.1 hours or longer and 48 hours or shorter, more preferably 0.5 hours or longer and 24 hours or shorter, because each of a pore size and a pore volume can be properly controlled in the porous material and the outer surface area per unit mass of the porous material can be controlled in a suitable range. The partial pressure of the active gas is usually 10% or more and 100% or less, preferably 30% or more and 100% or less.

After the activation treatment, cooling treatment to room temperature may be performed, if necessary. The cooling treatment can be performed, for example, in a nitrogen atmosphere, an argon atmosphere, an oxygen atmosphere, or an air atmosphere. The cooling is preferably performed in a nitrogen atmosphere because a pore size can be properly controlled in the porous material.

The porous material obtained by the activation treatment and the cooling treatment may be washed, if necessary, by a known method or the like.

The porous material can be obtained by properly setting the production conditions mentioned above.

### [Hydrogen Purification Apparatus]

The hydrogen purification apparatus of the present embodiment contains the porous material of the present embodiment as an adsorbent in a PSA method.

The adsorbent may be formed from only a single type of porous material or plural types of porous materials or may be formed in combination with an additional known member. Examples of the porous material include activated carbon and zeolite. Examples of the additional known member include alumina and silica gel.

The hydrogen purification apparatus is not particularly limited as long as the apparatus separates and purifies hydrogen by a pressure swing adsorption method. Specifically, the hydrogen purification apparatus is an apparatus based on the pressure swing adsorption method by which hydrogen gas is purified at a high purity from a gas containing hydrogen gas. The gas containing hydrogen gas is preferably a hydrogen-rich gas containing a large amount of hydrogen. Examples of such a gas include hydrogen-rich gases containing 20% by volume or more of hydrogen.

The porous material is housed, as an adsorbent that purifies hydrogen gas at a high purity by adsorbing and removing impurities such as water, methane, carbon dioxide, carbon monoxide, and nitrogen from the gas containing hydrogen gas under increased pressure, in the hydrogen purification apparatus.

A larger pressure increases the difference among the respective amounts of components adsorbed from impurities containing hydrogen per unit amount of the adsorbent. The hydrogen purification apparatus exploits the fact that the difference in adsorption capacity between hydrogen and impurities is large in an increased-pressure environment, and separates and recovers hydrogen from the impurities by preferentially adsorbing impurities, which are more easily adsorbed than hydrogen, onto the adsorbent. On the other hand, increase in pressure requires time to reach a predetermined pressure, and one adsorption-desorption cycle takes a longer time. Therefore, a pressure increased too much causes reduction in hydrogen purification efficiency. For these reasons, the adsorption pressure is preferably 500 kPa or higher and 900 kPa or lower.

A smaller pressure at the time of desorption can be more different from the adsorption pressure and enables more impurities to be desorbed in a desorption step. On the other hand, decrease in a pressure to be smaller than atmospheric pressure requires time to reach a predetermined pressure, and one adsorption-desorption cycle takes a longer time. Therefore, a pressure decreased too much causes reduction in hydrogen purification efficiency. For these reasons, the desorption pressure is preferably 90 kPa or higher and 110 kPa or lower, more preferably 95 kPa or higher and 105 kPa or lower.

Examples of the gas containing impurities for obtaining hydrogen include hydrogen-containing gases such as steam-reformed gases derived from, for example, off-gas from petrochemical plants, natural gases, and naphtha; coke oven gases; biomethane; and reformed gases obtained through the reaction of methanol with water vapor. The gas composition thereof largely depends on the properties of a starting material and reforming conditions. For example, a gas containing 77 vol % of hydrogen, 2.5 vol % of methane, and 18 vol % of carbon dioxide is described as a steam-reformed gas derived from a natural gas in the Document (J. Vac. Soc. Jpn, Vol. 43, No. 12, 2000, 1088-1093). Also, a gas containing 56 vol % of hydrogen, 26.5 vol % of methane, and 6.8 vol % of carbon dioxide is described as a steam-reformed gas derived from coke in this Document. Further, a gas containing 74 vol % of hydrogen and 24 vol % of carbon dioxide is described as a steam-reformed gas derived from methanol in this Document.

### EXAMPLES

Hereinafter, the present invention will be specifically described with reference to Examples and Comparative Examples. However, the present invention is not limited by these Examples by any means.

### Example 1

To 100 parts by mass of a palm tree kernel shell-derived carbon powder having a particle size of substantially 0.01 mm, 25 parts by mass of hard pitch and 15 parts by mass of coal tar were added while water was added, and the mixture was kneaded. The obtained kneaded product was charged into an extrusion granulator and shaped into a cylindrical form having a diameter of 2.0 mm in a cross-sectional shape. In a rotary kiln, the shaped product in a cylindrical form thus obtained was heated over approximately 5 hours until a final temperature became 800° C., while air was eliminated, to obtain a carbonization treatment product. Then, water vapor was added thereto as an activating gas at a rate of 100 L per minute, and activation treatment was performed for 30 minutes to obtain a porous material which was activated carbon.

### Example 2

A porous material was obtained by the same method as in Example 1 except that the activation treatment time was set to 40 minutes instead of 30 minutes.

### Example 3

A porous material was obtained by the same method as in Example 1 except that the activation treatment time was set to 50 minutes instead of 30 minutes.

### Example 4

A porous material was obtained by the same method as in Example 1 except that carbon dioxide was used as the activating gas instead of water vapor; and the activation treatment time was set to 100 minutes instead of 30 minutes.

### Example 5

A porous material was obtained by the same method as in Example 1 except that carbon dioxide was used as the activating gas instead of water vapor; and the activation treatment time was set to 120 minutes instead of 30 minutes.

### Example 6

A porous material was obtained by the same method as in Example 1 except that a carbon powder having a particle size of substantially 0.05 mm was used instead of the carbon powder having a particle size of substantially 0.01 mm; and the activation treatment time was set to 90 minutes instead of 30 minutes.

### Comparative Example 1

A porous material was obtained by the same method as in Example 1 except that the activation treatment time was set to 10 minutes instead of 30 minutes.

### Comparative Example 2

A porous material was obtained by the same method as in Example 1 except that the activation treatment time was set to 20 minutes instead of 30 minutes.

### Comparative Example 3

A porous material was obtained by the same method as in Example 4 except that the activation treatment time was set to 60 minutes instead of 100 minutes.

### Comparative Example 4

A porous material was obtained by the same method as in Example 6 except that the diameter in the cross-sectional shape of the shaped product in a cylindrical form was set to 4.0 mm in shaping; and the activation treatment time was set to 60 minutes instead of 90 minutes.

### (1) Average Particle Size (D50)

The average particle size (D50) of the carbon powder was measured as a volume-based median size using a laser diffraction-light scattering particle size distribution measurement apparatus (MT3300EXII (trade name) manufactured by MicrotracBEL Corp.).

### (2) Amount of Acetone Adsorbed

The amount of acetone adsorbed (% by mass fraction) by the porous material was measured in accordance with the method of JIS K 1474: 2014.

### (3) Pore Size Distribution

The pore size distribution of the porous material was measured using a specific surface area/pore distribution measurement apparatus (BELSORP®-max (trade name) manufactured by MicrotracBEL Corp.). An adsorption pressure in equilibrium and an amount of a gas adsorbed at each measurement point were measured at −196° C. using nitrogen as an adsorbed gas to obtain an adsorption isotherm. The pore size distribution was determined by analyzing the obtained adsorption isotherm by the GCMC method. Analysis software (BELMaster™ manufactured by MicrotracBEL Corp.) was used in the analysis.

### (4) Specific Surface Area

The specific surface area (m²/g), the pore volume per unit volume (mL/mL), and the pore volume per unit mass (mL/g) of the porous material were measured using a specific surface area/pore distribution measurement apparatus (BELSORP®-minill (trade name) manufactured by MicrotracBEL Corp.). An adsorption pressure in equilibrium and an amount of a gas adsorbed at each measurement point were measured at −196° C. using nitrogen as an adsorbed gas to obtain an adsorption isotherm. The specific surface area was determined by analyzing the obtained adsorption isotherm by the BET method. Analysis software (BELMaster™ manufactured by MicrotracBEL Corp.) was used in the analysis.

### (5) Amount of Hydrogen Adsorbed

The amount of hydrogen adsorbed (NmL/g) by the porous material was measured using a specific surface area/pore distribution measurement apparatus (BELSORP®-max (trade name) manufactured by MicrotracBEL Corp.). An adsorption pressure in equilibrium and an amount of a gas adsorbed at each measurement point were measured at 25° C. using hydrogen as an adsorbed gas. The amount of hydrogen adsorbed at an adsorption pressure of 500 kPa was calculated from a correlation equation obtained by the Langmuir approximation of the obtained adsorption isotherm.

### (6) Packing Density of Activated Carbon

The packing density (g/mL) of the porous material was measured by the method described in JIS K 1474: 2014.

### (7) Compressive Strength of Porous Material

The compressive strength per unit area (kgf/mm²) of the porous material was measured as follows: using the Kiya-type hardness tester, force was gradually applied in a direction perpendicular to the axial direction of the obtained porous material in a cylindrical form, and force applied when the porous material fractured was regarded as compressive strength (kgf). The compressive strength was divided by the product of the diameter (mm) of the cylinder and the length (mm) in the axial direction of the cylinder, and the obtained value was regarded as compressive strength per unit area (kgf/mm²). This measurement was performed as to the 30 specimens of the porous material, and an average value therefrom was used as the compressive strength per unit area of the porous material.

### (8) Outer Surface Area of Porous Material

The outer surface area per unit mass (m²/g) of the porous material was measured using a specific surface area/pore distribution measurement apparatus (BELSORP®-max (trade name) manufactured by MicrotracBEL Corp.). An adsorption pressure in equilibrium and an amount of a gas adsorbed at each measurement point were measured at −196° C. using nitrogen as an adsorbed gas to obtain an adsorption isotherm. The outer surface area was determined by analyzing the obtained adsorption isotherm by t-Plot. Analysis software (BELMaster™ manufactured by MicrotracBEL Corp.) was used in the analysis.

### (9) Amount of Methane Adsorbed

The amount of methane adsorbed (mL/mL) using the porous material was measured as follows: the amount was measured using a specific surface area/pore distribution measurement apparatus (BELSORP®-max (trade name) manufactured by MicrotracBEL Corp.). An adsorption pressure in equilibrium and an amount of a gas adsorbed at each measurement point were measured at 25° C. using methane as an adsorbed gas. An amount of methane adsorbed at an adsorption pressure of 300 kPa, x1, and an amount of methane adsorbed at an adsorption pressure of 25 kPa, x2, were calculated from a correlation equation obtained by the Langmuir approximation of the obtained adsorption isotherm. The difference therebetween (x1−x2) was obtained.

### (10) Amount of Carbon Dioxide Adsorbed

The amount of carbon dioxide adsorbed (mL/mL) using the porous material was measured as follows: the amount was measured using a specific surface area/pore distribution measurement apparatus (BELSORP®-max (trade name) manufactured by MicrotracBEL Corp.). An adsorption pressure in equilibrium and an amount of a gas adsorbed at each measurement point were measured at 25° C. using carbon dioxide as an adsorbed gas. An amount of carbon dioxide adsorbed at an adsorption pressure of 300 kPa, y1, and an amount of carbon dioxide adsorbed at an adsorption pressure of 25 kPa, y2, were calculated from a correlation equation obtained by the Langmuir approximation of the obtained adsorption isotherm. The difference therebetween (y1−y2) was obtained.

These results are shown in Tables 1 and 2.

TABLE 1

| | | Example | Example | Example | Example | Example | Example |
|---|---|---|---|---|---|---|---|
| | | 1 | 2 | 3 | 4 | 5 | 6 |
| Amount of acetone | | 14.4 | 16.7 | 20.8 | 17.2 | 21.3 | 30.2 |
| adsorbed (A) | | | | | | | |
| (% by mass fraction) | | | | | | | |
| Pore volume per unit | | 0.150 | 0.155 | 0.171 | 0.174 | 0.195 | 0.197 |
| volume | | | | | | | |
| (pore size: 0.6-1.5 nm) | | | | | | | |
| (mL/mL) | | | | | | | |
| Specific surface area | | 630 | 710 | 820 | 680 | 820 | 1190 |
| (m²/g) | | | | | | | |
| Pore volume per unit mass | | 0.23 | 0.25 | 0.29 | 0.28 | 0.33 | 0.42 |
| (pore size: 0.6-1.5 nm) (B) | | | | | | | |
| (mL/g) | | | | | | | |
| A/B ratio | | 62.6 | 66.8 | 71.7 | 61.4 | 64.5 | 71.9 |
| Amount of hydrogen | | 2.2 | 2.3 | 2.7 | 2.4 | 2.9 | 2.2 |
| adsorbed (mL/g) (C) | | | | | | | |
| C/B ratio | | 9.3 | 9.0 | 9.3 | 8.6 | 8.6 | 5.3 |
| Packing density (g/mL) | | 0.65 | 0.62 | 0.59 | 0.62 | 0.59 | 0.47 |
| Compressive strength per | | 1.34 | 1.31 | 1.28 | 1.42 | 1.35 | 0.71 |
| unit area (kgf/mm²) | | | | | | | |
| Outer surface area per unit | | 3.2 | 4.8 | 4.0 | 3.9 | 4.6 | 0.3 |
| mass (m²/g) | | | | | | | |
| Amount of | 300 kPa (x1) | 27.6 | 28.9 | 25.8 | 26.8 | 27.3 | 27.1 |
| methane | 25 kPa (x2) | 6.6 | 6.5 | 5.5 | 5.9 | 6.3 | 4.6 |
| adsorbed | x1 − x2 | 21.0 | 22.4 | 20.3 | 20.9 | 21.0 | 22.5 |
| (mL/mL) | | | | | | | |
| Amount of | 300 kPa (y1) | 47.7 | 53.0 | 47.0 | 52.0 | 57.3 | 48.1 |
| carbon | 25 kPa (y2) | 14.8 | 13.7 | 11.6 | 13.7 | 12.6 | 13.8 |
| dioxide | y1 − y2 | 32.9 | 39.4 | 35.4 | 38.0 | 44.7 | 34.3 |
| adsorbed | | | | | | | |
| (mL/mL) | | | | | | | |

TABLE 2

| | | Comparative | Comparative | Comparative | Comparative |
|---|---|---|---|---|---|
| | | Example 1 | Example 2 | Example 3 | Example 4 |
| Amount of acetone adsorbed | | 10.2 | 12.1 | 12.1 | 15.4 |
| (A) (% by mass fraction) | | | | | |
| Pore volume per unit volume | | 0.120 | 0.133 | 0.128 | 0.136 |
| (pore size: 0.6-1.5 nm) | | | | | |
| (mL/mL) | | | | | |
| Specific surface area (m²/g) | | 450 | 530 | 480 | 610 |
| Pore volume per unit mass | | 0.171 | 0.199 | 0.191 | 0.212 |
| (pore size: 0.6-1.5 nm) (B) | | | | | |
| (mL/g) | | | | | |
| A / B ratio | | 59.6 | 60.8 | 63.4 | 72.6 |
| Amount of hydrogen adsorbed | | 1.9 | 2.1 | 2.2 | 2.3 |
| (mL/g) (C) | | | | | |
| C / B ratio | | 10.9 | 10.6 | 11.7 | 10.9 |
| Packing density (g/mL) | | 0.70 | 0.67 | 0.67 | 0.64 |
| Compressive strength per unit | | 1.55 | 1.46 | 1.57 | 0.59 |
| area (kgf / mm²) | | | | | |
| Outer surface area per unit | | 4.2 | 3.4 | 4.6 | 0.4 |
| mass (m²/g) | | | | | |
| Amount of | 300 kPa (x1) | 24.5 | 25.9 | 24.2 | 25.4 |
| methane | 25 kPa (x2) | 6.4 | 6.6 | 4.6 | 5.7 |
| adsorbed | x1 − x2 | 18.1 | 19.3 | 19.6 | 19.7 |
| (mL/mL) | | | | | |
| Amount of | 300 kPa (y1) | 36.5 | 41.8 | 46.8 | 46.7 |
| carbon dioxide | 25 kPa (y2) | 16.9 | 15.8 | 15.6 | 15.4 |
| adsorbed | y1 − y2 | 19.6 | 26.0 | 31.2 | 31.3 |
| (mL/mL) | | | | | |

In all of Examples 1 to 6, the amount of methane adsorbed (x1−x2) is 20 mL/mL or more, and the amount of carbon dioxide adsorbed (y1−y2) is 32 mL/mL or more. This indicates a large difference between the amount of methane adsorbed at an adsorption pressure and the amount of methane adsorbed at a desorption pressure, and a large difference between the amount of carbon dioxide adsorbed at an adsorption pressure and the amount of carbon dioxide adsorbed at a desorption pressure. In short, the porous material according to the present embodiment is found to have high adsorption and desorption performance for impurities, particularly, methane and carbon dioxide, when used as an adsorbent in a PSA method, and be able to efficiently perform hydrogen purification.

In Comparative Examples 1 to 4, both the amount of methane adsorbed (x1−x2) and the amount of carbon dioxide adsorbed (y1−y2) are values lower than those obtained using the porous material according to the present embodiment. This indicates a smaller difference between the amount of methane adsorbed at an adsorption pressure and the amount of methane adsorbed at a desorption pressure, and a smaller difference between the amount of carbon dioxide adsorbed at an adsorption pressure and the amount of carbon dioxide adsorbed at a desorption pressure than those of the porous material according to the present embodiment. In short, the porous material obtained in each Comparative Example is found to have no high adsorption and desorption performance for impurities, particularly, methane and carbon dioxide, when used as an adsorbent in a PSA method, and be unable to sufficiently efficiently perform hydrogen purification.

The present application is based on the Japanese patent application filed on Mar. 9, 2023 (Japanese Patent Application No. 2023-036499), the contents of which are incorporated herein by reference.

### INDUSTRIAL APPLICABILITY

The porous material for hydrogen purification of the present embodiment has high adsorption and desorption performance for impurities, particularly, methane and carbon dioxide, when used as an adsorbent in a pressure swing adsorption method, and can efficiently perform hydrogen purification. Hence, the porous material for hydrogen purification can be suitably used in, for example, a hydrogen purification apparatus.

1. A porous material for hydrogen purification, the porous material being activated carbon, wherein an amount of acetone adsorbed is 12.5% by mass fraction or more, and a pore volume per unit volume of a pore having a size of 0.6 nm or larger and 1.5 nm or smaller is 0.140 mL/mL or more.

2. The porous material according to claim 1, wherein a specific surface area is 550 m²/g or more and 1600 m²/g or less, and when the amount of acetone adsorbed is defined as A (% by mass fraction) and a pore volume per unit mass of the pore having a size of 0.6 nm or larger and 1.5 nm or smaller is defined as B (mL/g), an A/B ratio is 72.5 or less.

3. The porous material according to claim 1, wherein when a pore volume per unit mass of the pore having a size of 0.6 nm or larger and 1.5 nm or smaller is defined as B (mL/g) and an amount of hydrogen adsorbed per unit mass at an adsorption temperature of 25° C. and an adsorption pressure of 500 kPa is defined as C (NmL/g), a C/B ratio is 10.5 or less.

4. The porous material according to claim 1, wherein a packing density is 0.45 g/mL or more and 0.80 g/mL or less.

5. The porous material according to claim 1, wherein compressive strength per unit area is 0.60 kgf/mm² or more.

6. A method for producing a porous material according to claim 1, comprising the step of shaping a starting material comprising a carbon powder having a particle size of 0.15 mm or smaller into a granular form.

7. A hydrogen purification apparatus comprising a porous material according to claim 1.
